(19) United States
(12) Patent Application Publication
(10) Pub. No.: US 2013/0050030 A1
(43) Pub. Date: Feb. 28, 2013

(54) COUPLER APPARATUS AND COUPLING ELEMENT

(71) Applicant: Kabushiki Kaisha Toshiba, Tokyo (JP)

(72) Inventor: Hiroshi Shimasaki, Kunitachi-shi (JP)

(73) Assignee: KABUSHIKI KAISHA TOSHIBA, Tokyo (JP)

(21) Appl. No.: 13/665,775

(22) Filed: Oct. 31, 2012

Related U.S. Application Data
(63) Continuation of application No. 12/955,482, filed on Nov. 29, 2010.

(30) Foreign Application Priority Data
Nov. 27, 2009 (JP) 2009-270598

(51) Int. Cl. H01Q 9/06

(52) U.S. Cl. 343/700 MS

(57) ABSTRACT

In one embodiment, a coupling element configured to satisfy the following conditions. The element has a tabular shape having first to fourth open ends. Lengths of current paths from a reference point to the first to fourth ends is an integral multiple of ¼ of a wavelength of a central frequency. Two paths in the four paths are partially parallel to a first direction and opposite to each other. Two paths in the four paths are partially parallel to a second direction orthogonal to the first direction and opposite to each other. The first and second ends are provided at symmetrical positions, and the third and fourth ends are provided at symmetrical positions with a first straight line. The first and third ends are provided at symmetrical positions, and the second and fourth ends are provided at symmetrical positions with a second straight line orthogonal to the first straight line.

### CROSS-REFERENCE TO RELATED APPLICATIONS

This application is a continuation of U.S. application Ser. No. 12/955,482, filed Nov. 29, 2010, and entitled “COUPLER APPARATUS AND COUPLING ELEMENT,” which is based upon and claims the benefit of priority from Japanese Patent Application No. 2009-270598, filed Nov. 27, 2009; the entire contents of both of which are incorporated herein by reference.

### FIELD

Embodiments described herein relate generally to a coupler apparatus that transmits or receives electromagnetic waves to or from another coupler apparatus arranged to be apart from each other and to a coupling element that produces electromagnetic coupling with another coupling element arranged to be apart from each other.

### BACKGROUND

Development of Transfer JET has advanced as a proximity wireless communication system between two communication devices which are in proximity to each other to form a gap of approximately several cm therebetween.

To perform communication by utilizing this type of proximity wireless communication system, coupler apparatuses having two communication devices mounted thereon, respectively, are proximally positioned to face each other. Each coupler apparatus includes a coupling element and utilizes electromagnetic coupling between the coupling elements to transmit or receive electromagnetic waves.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a perspective view of a coupler apparatus according to an embodiment;

FIG. 2 is a partially cutaway side view of a YZ plane in FIG. 1;

FIG. 3 is a view showing a planar shape of a coupling element depicted in FIG. 1;

FIG. 4 is a perspective view showing an appearance of an information processing apparatus as an example of a device on which the coupler apparatus depicted in FIG. 1 is mounted;

FIG. 5 is a block diagram showing the information processing apparatus depicted in FIG. 4;

FIG. 6 is a view showing current paths in the coupling element depicted in FIG. 1;

FIG. 7 is a view showing examples of four states when arranging two L-shaped coupling elements to face each other;

FIG. 8 is a view showing frequency characteristics of a coupling degree in each of the four states depicted in FIG. 7;

FIG. 9 is a view showing frequency characteristics of a degree of coupling in each of the four states depicted in FIG. 7;

FIG. 10 is a view showing examples of four states when arranging the two coupling elements depicted in FIG. 1 to face each other;

FIG. 11 is a view showing frequency characteristics of a degree of coupling in each of the four states depicted in FIG. 10;

FIG. 12 is a view showing frequency characteristics of a degree of coupling in each of the four states depicted in FIG. 10;

FIG. 13 is a view showing an example of a positional relationship between the coupling element and a ground plate in FIG. 1;

FIG. 14 is a view showing a modification of a shape in an XY plane of the coupling element;

FIG. 15 is a view showing a modification of a shape in the XY plane of the coupling element;

FIG. 16 is a view showing a modification of a shape in the XY plane of the coupling element;

FIG. 17 is a view showing a modification of a shape in the XY plane of the coupling element;

FIG. 18 is a view showing a modification of a shape in the XY plane of the coupling element;

FIG. 19 is a view showing a modification of a shape in the XY plane of the coupling element;

FIG. 20 is a view showing a modification of a shape in the XY plane of the coupling element;

FIG. 21 is a view showing an example of a positional relationship between a coupling element and a ground plate in a coupler apparatus using the coupling element having the shape depicted in FIG. 20;

FIG. 22 is a view showing an example of a positional relationship between a coupling element and a ground plate in a coupler apparatus using the coupling element having the shape depicted in FIG. 19;

FIG. 23 is a view showing an example of an arrangement state of the coupling element and a parasitic element;

FIG. 24 is a view showing a modification of a connecting conformation of the coupling element and a transmission/reception circuit;

FIG. 25 is a view showing a modification of the connecting conformation of the coupling element and the transmission/reception circuit;

FIG. 26 is a view showing an attachment example of a passive element;

FIG. 27 is a view showing a modified structural example of the ground plate;

FIG. 28 is a view showing a modification of a shape in the XY plane of the coupling element; and

FIG. 29 is a view showing examples of four states when arranging the two coupling elements depicted in FIG. 28 to face each other.

### DETAILED DESCRIPTION

Various embodiments will be described hereinafter with reference to the accompanying drawings.

In general, according to one embodiment, a coupling element configured to satisfy the following conditions (1) to (6). (1) The coupling element has a tabular shape having first, second, third, and fourth open ends. (2) Each of lengths of current paths from a reference point as a feeding point to the first, second, third, and fourth open ends is a length substantially corresponding to an integral multiple of ¼ of a wavelength of a central frequency of an electromagnetic wave transmitted or received to or from the other coupling element based on electromagnetic coupling. (3) At least two current paths in the four current paths are partially parallel to a first direction and opposite to each other. (4) At least two current paths in the four current paths are partially parallel to a second direction substantially orthogonal to the first direction and opposite to each other. (5) A first straight line running through a branching point at which the current path first branches as seen from the reference point is determined as a symmetric axis, the first and second open ends are provided at substantially symmetrical positions, and the third and fourth open ends are provided at substantially symmetrical positions. (6) A second straight line that runs through the branching point and is orthogonal to the first straight line is determined as a symmetric axis, the first and third open ends are provided at substantially symmetrical positions, and the second and fourth open ends are provided at substantially symmetrical positions.

Embodiments will now be described hereinafter with reference to the accompanying drawings.

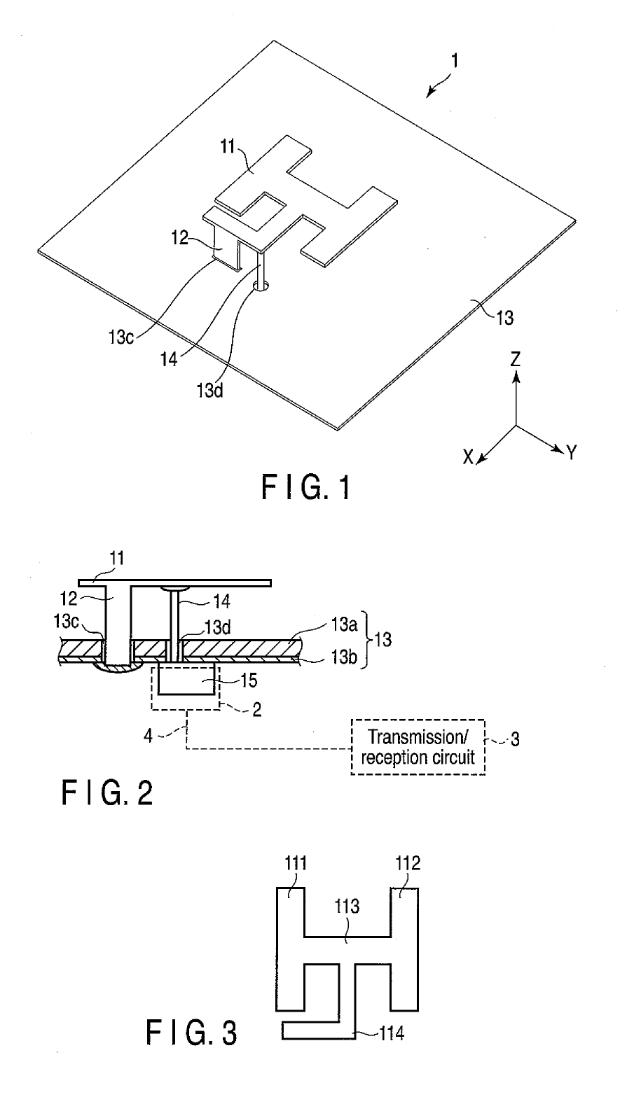

FIG. 1 is a perspective view of a coupler apparatus 1 according to an embodiment. FIG. 2 is a partially cutaway side view of a YZ plane in FIG. 1.

As shown in FIG. 1 and FIG. 2, the coupler apparatus 1 comprises a coupling element 11, a short-circuit element 12, a ground plate 13, a feeder line 14, and a connector 15.

The coupling element 11 can be obtained by forming a conductive material into such a shape as depicted in FIG. 1 and FIG. 2.

The coupling element 11 has a tabular shape, and its thickness direction coincides with a Z direction in FIG. 1. Further, the coupling element 11 has the following shape in a plane (an XY plane in FIG. 1) orthogonal to its thickness direction. As shown in FIG. 3, in the coupling element 11, two rectangular portions 111 and 112 are present in parallel to be apart from each other. In the coupling element 11, a coupling portion 113 is present in a state where it extends along an arrangement direction of the rectangular portions 111 and 112 to couple central parts of the rectangular portions 111 and 112 with each other. Moreover, in the coupling element 111, an L-shaped terminal portion 114 is present in a state where one end thereof is connected with the center of the coupling portion 113. The rectangular portions 111 and 112, the coupling portion 113, and the terminal portion 114 all have sizes that enable the high-frequency signal to be supplied in a substantially entire region.

The short-circuit element 12 has a rectangular tabular shape, and its thickness direction is orthogonal to the thickness direction of the coupling element 11. In FIG. 1, the thickness direction of the short-circuit element 12 coincides with the X direction. The short-circuit element 12 is bonded to the terminal portion 114 near an end portion thereof that is on an opposite side of the other end portion of the terminal portion 114 connected to the coupling portion 113. The short-circuit element 12 may be integral with or separated from the coupling element 11.

In the ground plate 13, an electrode 13b formed of a conducive material is provided on a substantially entire surface of a flat plate 13a formed of a dielectric material. This electrode 13b is electrically connected to, e.g., a metal housing of a communication device on which the coupler apparatus 1 is mounted. Therefore, the electrode 13b functions as a ground electrode. Further, through holes 13c and 13d are formed in the ground plate 13.

The short-circuit element 12 is arranged via the through hole 13c. The short-circuit element 12 is electrically connected to the electrode 13b based on, e.g., soldering.

The feeder line 14 is arranged via the through hole 13d. One end of the feeder line 14 is connected to the coupling element 11, and the other end of the same is connected to a connector 15.

The connector 15 is disposed to a surface of the ground plate 13 to which the electrode 13b is not provided. In a state where the coupler apparatus 1 is mounted on the communication device, a connector 2 is coupled with this connector 15. The connector 2 is connected with a transmission/reception circuit 3 mounted on the communication device through a cable 4. Furthermore, the connector 15 is electrically connected to the feeder line 14 and the cable 4 together with the connector 2.

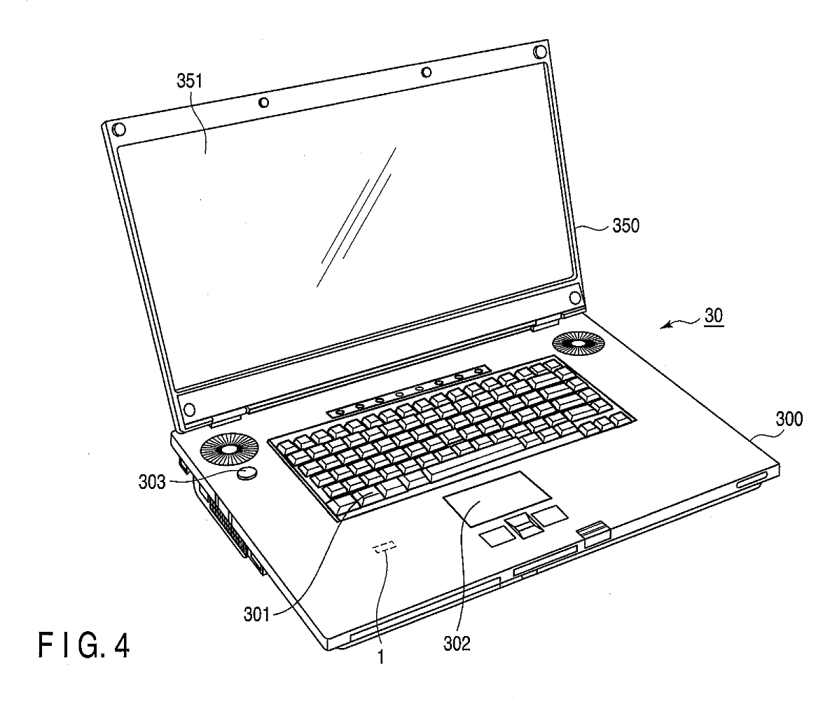

FIG. 4 is a perspective view showing an appearance of an information processing apparatus 30 as an example of a device on which the coupler apparatus 1 is mounted. This information processing apparatus 30 is realized as, e.g., a notebook type portable personal computer that can be driven by a battery.

The information processing apparatus 30 includes a main body 300 and a display unit 350. The display unit 350 is supported by the main body 300 to allow its swiveling motion. The display unit 350 can form an opened state where an upper surface of the main body 300 is exposed and a closed state where the upper surface of the main body 300 is covered. In the display unit 350, a liquid crystal display (LCD) 351 is provided.

The main body 300 has a thin box-like housing. In the main body 300, a keyboard 301, a touch pad 302, a power switch 303, and others are arranged in a state where these members are exposed to the outside of the housing from an upper surface of the housing. Furthermore, in the main body 300, the coupler apparatus 1 is provided in the housing. A direction of the coupler apparatus 1 in the main body 300 may be arbitrary. However, the Z direction in FIG. 1 is typically set to coincide with a direction orthogonal to the upper surface of the housing of the main body 300. Moreover, the coupling element 11 rather than the ground plate 13 is typically placed near the upper surface of the housing of the main body 300.

The coupler apparatus 1 is utilized to perform proximity wireless communication between the information processing apparatus 30 and the other non-illustrated apparatus. The proximity wireless communication is executed in a peer-to-peer system. A communication enabled range is, e.g., approximately 3 cm. Wireless connection between communication terminals is achieved only when a distance between the coupler apparatuses 1 mounted in the respective communication terminals becomes equal to or below the communication enabled range. Further, when the distance between the two coupler apparatuses 1 becomes equal to or below the communication enabled range, the wireless communication between the two communication terminals is achieved. Furthermore, data such as a data file specified by a user or a predetermined synchronization target data file is transmitted or received between the two communication terminals.

In the example depicted in FIG. 4, the coupler apparatus 1 is arranged below a region that functions as a palm rest (which will be referred to as a palm rest region hereinafter) on the upper surface of the main body 300. Therefore, a part of the palm rest region functions as a communication surface. That is, when the other communication terminal that is to perform the proximity wireless communication with the information processing apparatus 30 is moved closer to the palm rest region, the wireless connection between this communication terminal and the information processing apparatus 30 can be achieved.

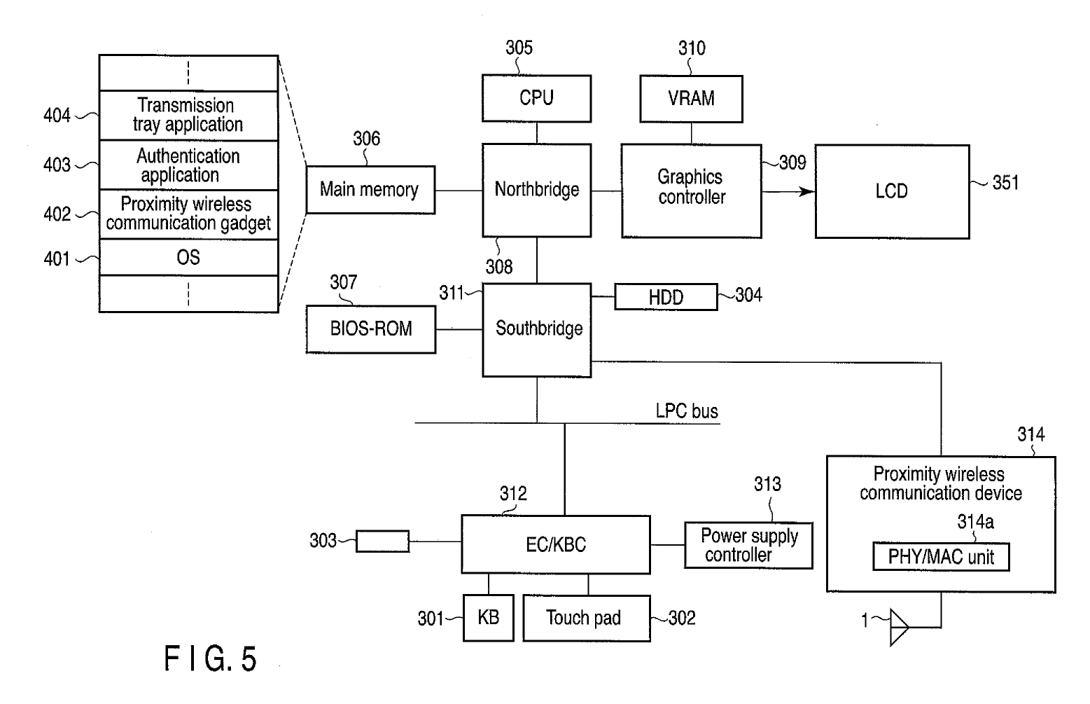

FIG. 5 is a block diagram of the information processing apparatus 30. It is to be noted that like reference numerals denote parts equal to those in FIG. 4.

The information processing apparatus 30 includes the coupler apparatus 1, the keyboard 301, the touch pad 302, the power switch 303, and the LCD 351, and this apparatus also includes a hard disk drive (HDD) 304, a CPU 305, a main memory 306, a basic input/output system-ROM (BIOS-ROM) 307, a northbridge 308, a graphics controller 309, a video memory (VRAM) 310, a southbridge 311, an embedded controller/keyboard controller IC (EC/KBC) 312, a power supply controller 313, and a proximity wireless communication device 314.

The hard disk drive 304 stores codes required to execute an operating system (OS) or various kinds of programs such as an BIOS update program.

The CPU 305 executes various kinds of programs loaded to the main memory 306 from the hard disk drive 304 in order to control operations of the information processing apparatus 30. Programs executed by the CPU 305 include an operating system 401, a proximity wireless communication gadget application program 402, an authentication application program 403, or a transmission tray application program 404.

Additionally, the CPU 305 executes a BIOS program stored in the BIOS-ROM 307 to control hardware.

The northbridge 308 connects a local bus of the CPU 305 and the southbridge 311. The northbridge 308 has a built-in memory controller that controls access of the main memory 306. Further, the northbridge 308 has a function of executing communication with the graphics controller 309 via an AGP bus and the like.

The graphics controller 309 controls the LCD 351. The graphics controller 309 generates a video signal representing a display image that is displayed in the LCD 351 from display data stored in the video memory 310. It is to be noted that the display data is written into the video memory 310 under control of the CPU 305.

The southbridge 311 controls devices on an LPC bus. The southbridge 311 has a built-in ATA controller configured to control the hard disk drive 304. Furthermore, the southbridge 311 has a function of controlling access of the BIOS-ROM 307.

The embedded controller/keyboard controller IC (EC/KBC) 312 is a one-chip microcomputer in which an embedded controller and a keyboard controller are integrated. The embedded controller controls a power supply controller to turn on/off the information processing apparatus 30 in accordance with operations of the power switch 303 by a user. The keyboard controller controls the keyboard 301 and the touch pad 302.

The power supply controller 313 controls operations of a non-illustrated power supply apparatus. It is to be noted that the power supply apparatus generates operation power for each unit in the information processing apparatus 30.

The proximity wireless communication device 314 includes a PHY/MAC unit 314a. The PHY/MAC unit 314a operates under control of the CPU 305. The PHY/MAC unit 314a communicates with the other communication terminal through the coupler apparatus 1. This proximity wireless communication device 314 corresponds to the transmission/reception circuit 3 in FIG. 2.

It is to be noted that a peripheral component interconnect (PCI) bus is utilized for data transfer between the proximity wireless communication device 314 and the southbridge 311. It is to be noted that a PCI Express may be used in place of the PCI.

Operations of the thus configured coupler apparatus 1 will now be explained.

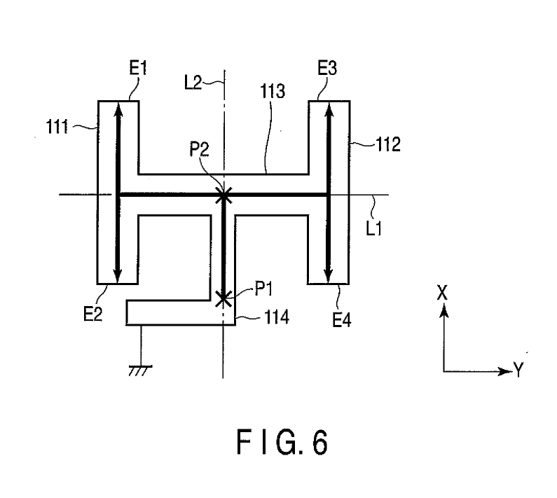

When a high-frequency signal is transmitted from the transmission/reception circuit 3 connected to the coupler apparatus 1 as shown in FIG. 2, this high-frequency signal is supplied to the coupling element 11 via the cable 4, the connector 2, the connector 15, and the feeder line 14. Then, a current associated with the high-frequency signal is produced in the coupling element 11. A heavy line in FIG. 6 indicates a current path in the coupling element 11 at this moment.

That is, a connecting point of the feeder line 14 is a feeding point P1 for the coupling element 11. Furthermore, the current path is parallel to the terminal portion 114 from the feeding point P1 to a branching point P2. It is to be noted that the branching point P2 corresponds to an intersection of the coupling portion 113 and the terminal portion 114. In the terminal portion 114, the current is produced in the substantially entire region thereof. Therefore, it can be considered that the current path in the terminal portion 114 runs through a central part of the terminal portion 114.

The current path branches into two at the branching point P2. Moreover, the two current paths extend toward the rectangular portions 111 and 112 along the coupling portion 113. In the coupling portion 113, the current is produced in the substantially entire region thereof. Therefore, it can be considered that the current paths in the coupling portion 113 run through a central part of the coupling portion 113.

In the rectangular portions 111 and 112, the currents are produced in the substantially entire regions thereof. Therefore, it can be considered that the current path in the rectangular portion 111 or 112 runs through a central part of the rectangular portion 111 or 112. Therefore, the current path branches into two at the center of the rectangular portion 111 to reach end portions E1 and E2 along upper and lower edge portions in FIG. 6. In the rectangular portion 112, likewise, the current path branches into two at the center of the rectangular portion 112 to reach end portions E3 and E4 along upper and lower edge portions in FIG. 6.

In this manner, the four current paths that reach the end portions E1, E2, E3, and E4 from the feeding point P1, respectively, are formed. Thus, the end portions E1, E2, E3, and E4 function as open ends. Additionally, each of the four current paths has a part that is common to the other current paths. That is, the four current paths form a common current path from the feeding point P1 to the branching point P2. Further, the two current paths form a common current path from the branching point P2 to a boundary between the rectangular portion 111 and the coupling portion 113. The two current paths form a common current path from the branching point P2 to a boundary between the rectangular portion 112 and the coupling portion 113.

Meanwhile, a size of the coupling element 11 is determined to meet the following conditions (1) to (3).

(1) Lengths of the four current paths correspond to substantially ¼ of a wavelength λ of a central frequency of the high-frequency signal.

(2) The pair of end portions E1 and E2 are provided at substantially symmetrical positions and the pair of end portions E3 and E4 are similarly provided at substantially symmetrical positions with a straight line L1 being used as a symmetric axis.

(3) The pair of end portions E1 and E3 are provided at substantially symmetrical positions and the pair of end portions E2 and E4 are likewise provided at substantially symmetrical positions with a straight line L2 being used as a symmetric axis.

However, the straight lines L1 and L2 are straight lines that run through the branching point P2 and are orthogonal to each other.

As described above, each of the four current paths includes portions that face two directions substantially orthogonal to each other. Additionally, when the four current paths reaching the end portions E1, E2, E3, and E4 from the feeding point P1 are called first, second, third, and fourth current paths, respectively, the first current path and the third current path or the second current path and the fourth current paths are substantially symmetrical with the straight line L1 being used as the symmetric axis. Further, the first current path and the second current path or the third current path and the fourth current path are substantially symmetrical with the straight line L2 being used as the symmetric axis.

Therefore, at least two of the four current paths include portions that are parallel to the same direction (which will be referred to as a first direction) and opposed to each other. Furthermore, at least two of the four current paths include portions that are parallel to a direction (which will be referred to as a second direction) substantially orthogonal to the first direction and opposed to each other. It is to be noted that the first direction is a direction parallel to the straight line L1 and the second direction is a direction parallel to the straight line L2 in this embodiment, but this arrangement is not essential.

The current produced in the coupling element 11 of the coupler apparatus 1 on the transmission side as described above causes an electromagnetic wave around the coupler apparatus 1 on the transmission side. Moreover, this electromagnetic wave induces a current in the coupling element 11 of the coupler apparatus 1 on the reception side. In this manner, the high-frequency signal is transmitted or received between the two coupler apparatuses 1.

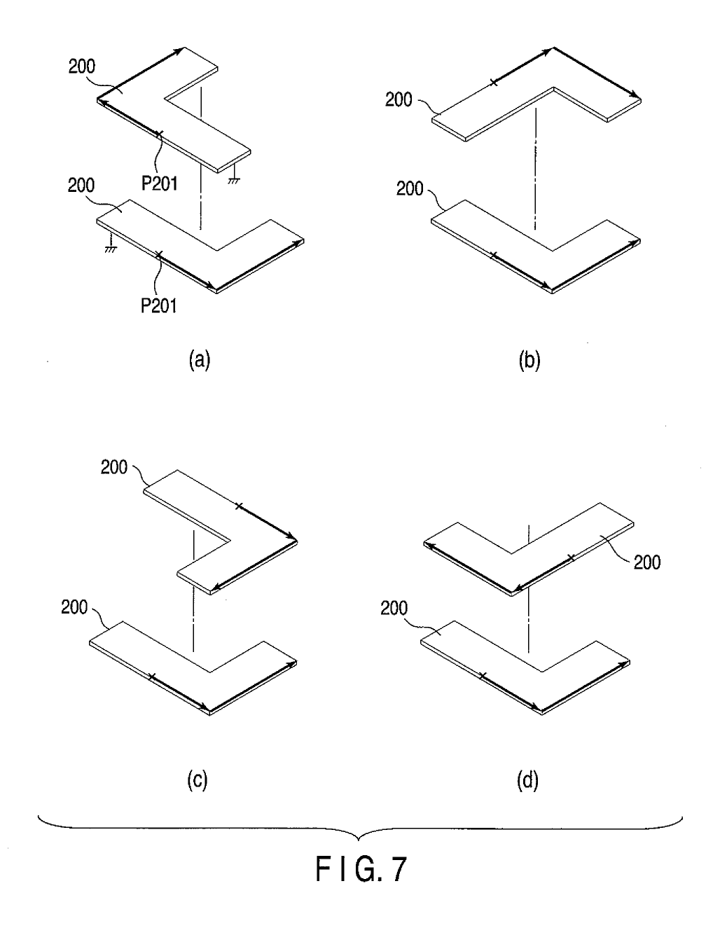

Here, such L-shaped coupling elements 200 as depicted in FIG. 7 are assumed as shapes different from that of the coupling element 11. It is to be noted that a feeding point is P201 in (a) of FIG. 7. Additionally, four directions shown in (a) to (d) in FIG. 7 are determined as 0 degree, 90 degrees, 180 degrees, and 270 degrees as relative directions of the two coupling elements 200, respectively.

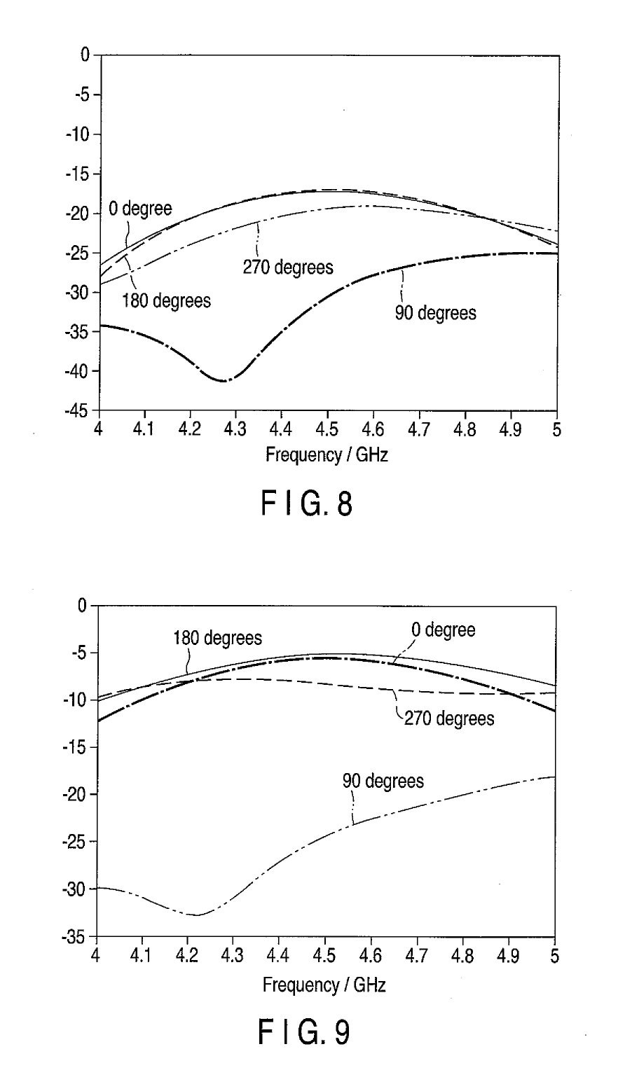

Each of FIG. 8 and FIG. 9 is a view showing frequency characteristics of coupling degrees in four states depicted in FIG. 7. It is to be noted that FIG. 8 and FIG. 9 show results obtained by performing simulation with a distance between the two coupling elements 200 being determined as 15 mm and 5 mm, respectively.

As can be understood from FIG. 8 and FIG. 9, a coupling degree of the coupling elements 200 is reduced by up to approximately 20 dB at 90 degrees in particular as compared with the other directions.

It can be considered that a main cause of this reduction is that a current whose direction is opposite to that of a current produced in one coupling element 200 is not produced in the other coupling element 200.

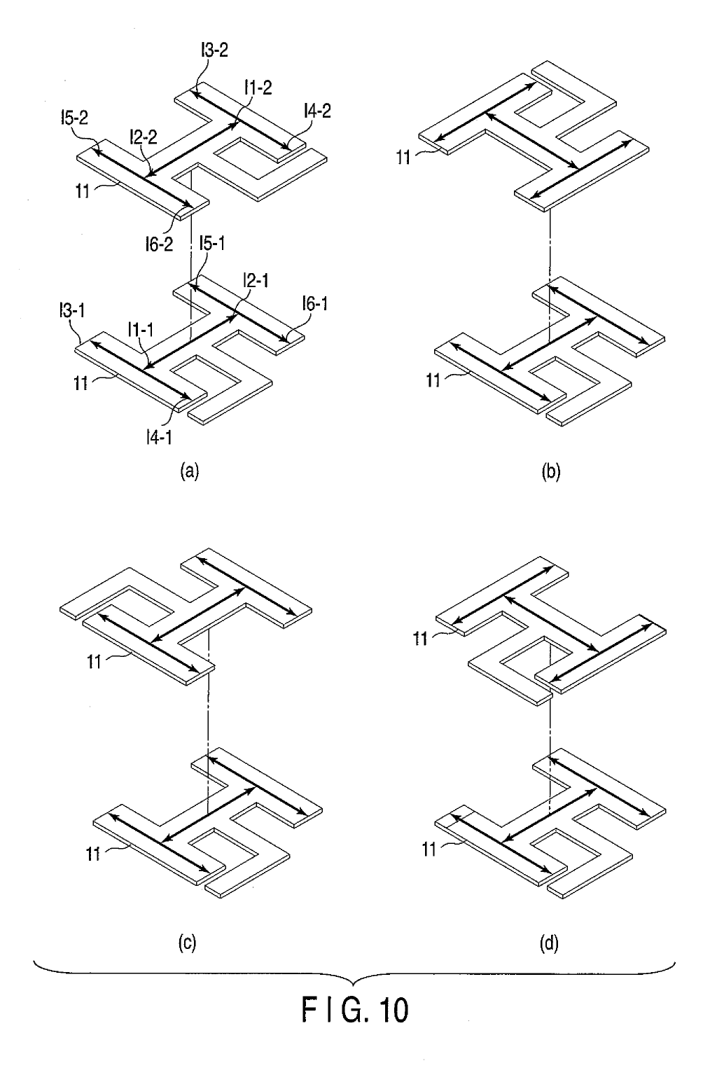

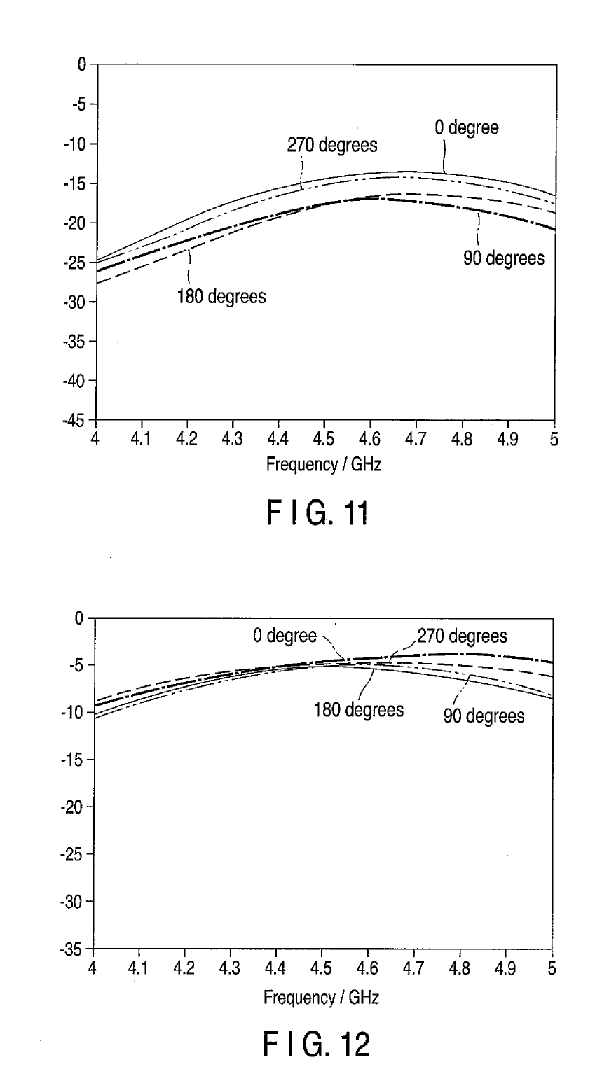

On the other hand, in regard to the coupling elements 11, four directions shown in (a) to (d) in FIG. 10 are determined as 0 degree, 90 degrees, 180 degrees, and 270 degrees, respectively. Furthermore, each of FIG. 11 and FIG. 12 shows frequency characteristics of coupling degrees in four states depicted in FIG. 10, respectively. FIG. 11 and FIG. 12 show results obtained by performing simulation with a distance between the two coupling elements 11 being determined as 15 mm and 5 mm, respectively.

As can be understood from FIG. 11 and FIG. 12, a reduction in the coupling degrees of the coupling elements 11 is suppressed to up to approximately 4 dB.

It can be considered that this suppression is realized since a current whose direction is opposite to that of a current produced in one coupling element 11 is produced in the other coupling element 11. Incidentally, assuming that currents flowing from the branching point P2 toward the rectangular portions 111 and 112 are represented as I1 and I2, currents branched from the current I1 for the end portions E1 and E2 are represented as I3 and I4, currents branched from the current I2 for the end portions E3 and E4 are represented as I5 and I6, “−1” is added to the above-described signs in regard to the respective currents concerning one coupling element 11, and “−2” is added to the above-described signs in regard to the respective currents concerning the other coupling element 11, the following currents have opposed directions in each of the four states shown in FIG. 10.

0 degree: I1-1 and I1-2; I2-1 and I2-2; I3-1 and I5-1; I4-2 and I6-2; I4-1 and I6-1; and I3-2 and I5-2.

90 degrees: I1-1, I4-2, and I6-2; I2-1, I3-2, and 15-2; I3-1, I5-1, and I2-2; and I4-1, I6-1, and I1-2.

180 degrees: I1-1 and I2-2; I2-1 and I1-2; I3-1 and 15-1, I3-2, and I5-2; and I4-1, I6-1, I4-2, and I6-2.

270 degrees: I1-1, I3-2, and I5-2; I2-1, I4-2, and 16-2; I3-1, I5-1, and I1-2; and I4-1, I6-1, and I2-2.

Thus, according to this embodiment, since a length of each of the four current paths substantially corresponds to λ/4, a resonant frequency in coupling of the two coupling elements 11 serves as a central frequency of the high-frequency signal, and the high-frequency signal can be efficiently transmitted or received. It is to be noted that, if the length of each of the four current paths substantially corresponds to an integral multiple of λ/4, resonance at the central frequency of the high-frequency signal occurs. Thus, the length of each of the four current paths may be nλ/4 (where n is an integer that is equal to or above 2). Setting each current path to nλ/4 is preferable when a longer element length must be assured for realization of an array, for example. On the other hand, if the length of each of the four current paths is up to λ/4, a distance from the feeding point to the open end of the coupling element 11 is shorter than that in an example where the length is nλ/4, thereby reducing the size of the coupling element 11.

Further, when the end portions E1 to E4 serving as the open ends of the respective four current paths has the positional relationship meeting the above-described conditions and the above-explained four current paths are formed, the coupling degree does not greatly vary even if the two coupling elements 11 relatively rotate, and transmission/reception can be stably performed.

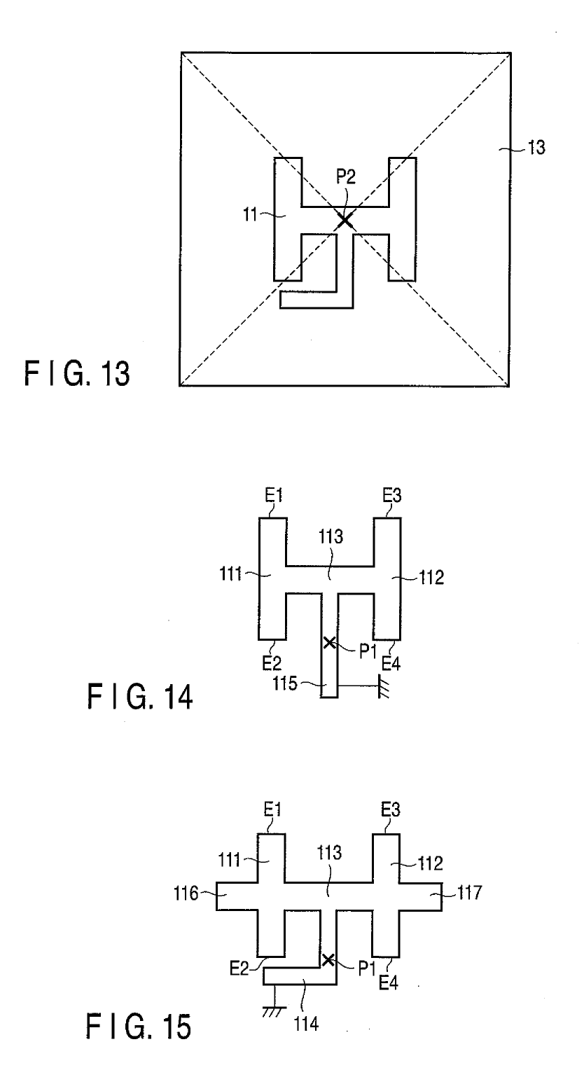

Meanwhile, electromagnetic coupling between the two coupler apparatuses 1 is achieved mainly by each coupling element 11. However, the ground plate 13 also affects an electromagnetic field. Therefore, it is desirable for a positional relationship between the coupling element 11 and the ground plate 13 to be set to a state shown in FIG. 13. That is, it is a state where the branching point P2 and the center of the ground plate 13 are aligned along the Z direction.

As a result, a reduction in coupling degree due to horizontal displacement of the two coupler apparatuses 1 facing each other can be decreased. It is to be noted that the horizontal displacement means displacement of the two coupler apparatuses 1 in a direction crossing an arrangement direction of the two coupler apparatuses 1.

It is to be noted that the coupling degree is improved when a width of each of the rectangular portions 111 and 112 of the coupling element 11 in the Y direction is increased. However, its improvement ratio is small.

Moreover, the coupling degree is improved by increasing a distance between the coupling element 11 and the ground plate 13 to some extent. However, there is a limit in improvement of the coupling degree based on an increase in the distance, and the size of the coupler apparatus 1 rises as the distance is increased. The distance should be appropriately set while considering these properties.

Additionally, the coupling degree is improved as an area of the ground plate 13 is increased. However, there is a limit in improvement of the coupling degree based on an increase in the area, and the size of the coupler apparatus 1 rises as the area is increased. The area should be appropriately set while considering these properties.

This embodiment can be modified in many ways as follows.

### First Modification

A shape in the XY plane of the coupling element 11 can be modified in many way as shown in FIG. 14 to FIG. 20 and described below. It is to be noted that, in FIG. 14 to FIG. 20, like reference numerals denote parts equal to those in FIG. 6.

A coupling element shown in FIG. 14 includes a linear terminal portion 115 in place of the L-shaped terminal portion 114.

A coupling element shown in FIG. 15 includes concave portions 116 and 117 obtained by extending a coupling portion 113 from rectangular portions 111 and 112, respectively.

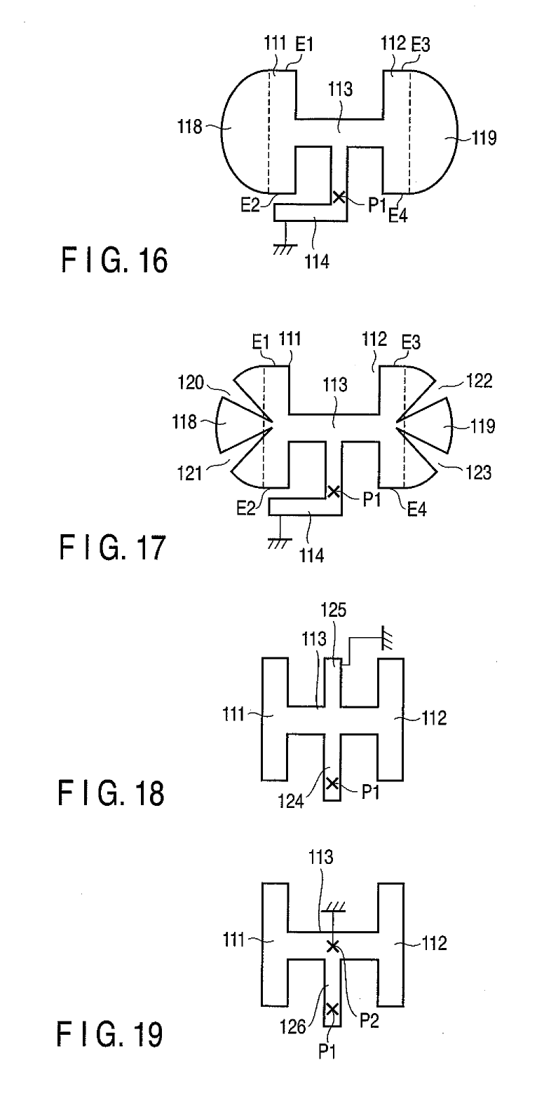

A coupling element shown in FIG. 16 includes semicircular added portions 118 and 119 bonded to rectangular portions 111 and 112, respectively.

In a coupling element shown in FIG. 17, V-like notches 120, 121, 122, and 123 are formed in rectangular portions 111 and 112 and added portions 118 and 119 in the shape depicted in FIG. 16. It is to be noted that the number of notches may be arbitrary.

A coupling element shown in FIG. 18 includes a linear terminal portion 124 in place of the L-shaped terminal portion 114 and also includes a terminal portion 125 obtained by extending the terminal portion 124 from a coupling portion 113. Furthermore, a short-circuit element 12 is provided to the terminal portion 125, and the coupling element is grounded through this terminal portion 125.

A coupling element shown in FIG. 19 includes a linear terminal portion 126 in place of the L-shaped terminal portion 114. Moreover, a short-circuit element 12 is provided immediately below a branching point P2, and the coupling element is grounded at the branching point P2.

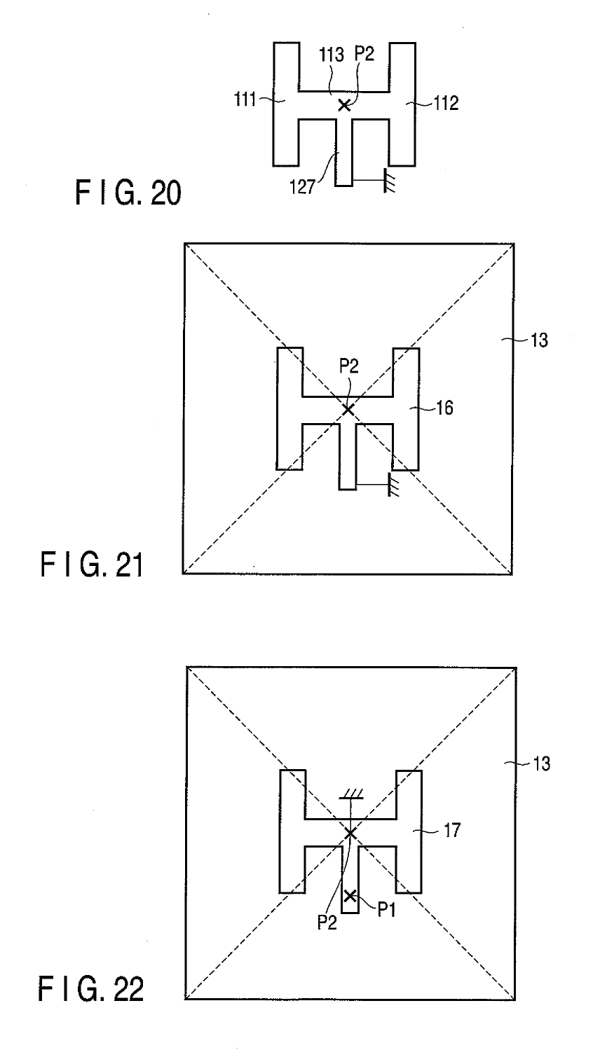

A coupling element shown in FIG. 20 includes a linear terminal portion 127 in place of the L-shaped terminal portion 114. Additionally, a short-circuit element 12 is provided to the terminal portion 127, and the coupling element is grounded through this terminal portion 127. Further, a feeder line is connected to a branching point P2 so that a feeding point can also function as the branching point P2.

It is to be noted that the plurality of modifications can be appropriately redundantly applied. For example, the shape shown in FIG. 14 can be determined as a basic shape, and any one of the modifications shown in FIG. 15 to FIG. 17 can be combined.

### Second Modification

In a coupler apparatus using a coupling element having the shape shown in FIG. 20, it is preferable for a positional relationship between this coupling element 16 and a ground plate 13 to be set to a state depicted in FIG. 21. That is, the branching point P2 which is also the feeding point and the center of the ground plate 13 are aligned along the Z direction.

Further, in a coupler apparatus using a coupling element having the shape depicted in FIG. 19, it is preferable for a positional relationship between this coupling element 17 and a ground plate 13 to be set to a state depicted in FIG. 22. That is, the branching point P2 which is also the grounding point and the center of the ground plate 13 are aligned along the Z direction.

### Third Modification

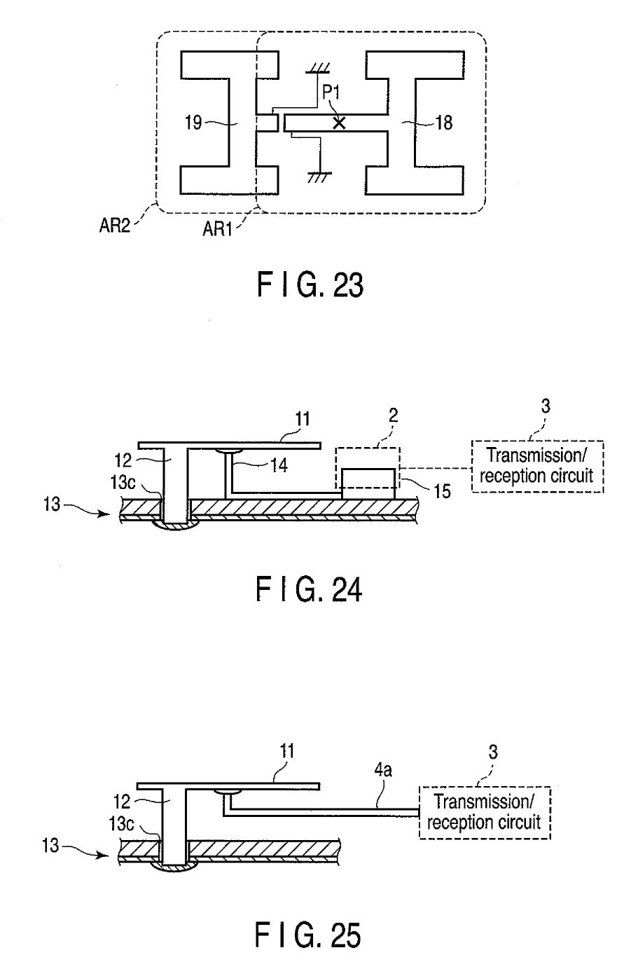

A parasitic element having the same configuration as that of the coupling element 11 or any coupling element in the respective modifications may be provided in proximity thereto. Although this parasitic element is grounded, it is not connected to a transmission/reception circuit. FIG. 23 is a view showing an example thereof, and a parasitic element 19 having the same configuration as that of the coupling element 18 shown in FIG. 14 is arranged in proximity thereto.

Based on such a configuration, a wider communication area AR2 than a communication area AR1 obtained by the coupling element 18 alone can be obtained.

### Fourth Modification

A circuit board of a communication device on which the coupler apparatus 1 is mounted may be utilized in place of the ground plate 13. That is, the coupling element 18 alone is treated as an independent component, and this coupling element may be disposed to the communication device.

### Fifth Modification

A connecting conformation of a coupling element 11 and a transmission/reception circuit 3 may be arbitrary. For example, such a conformation as shown in FIG. 24 or FIG. 25 can be used. In FIG. 24, a connector 15 is disposed to a surface on the same side as a surface of a ground plate 13 where the coupling element 11 is arranged. Further, a feeder line 14 is directly connected to the connector 15 without being inserted into a through hole 13d of the ground plate 13. In FIG. 25, a connector 15 is not provided, and a core wire 4a of a cable connected to a transmission/wire circuit 3 is soldered to a coupling element 11.

### Sixth Modification

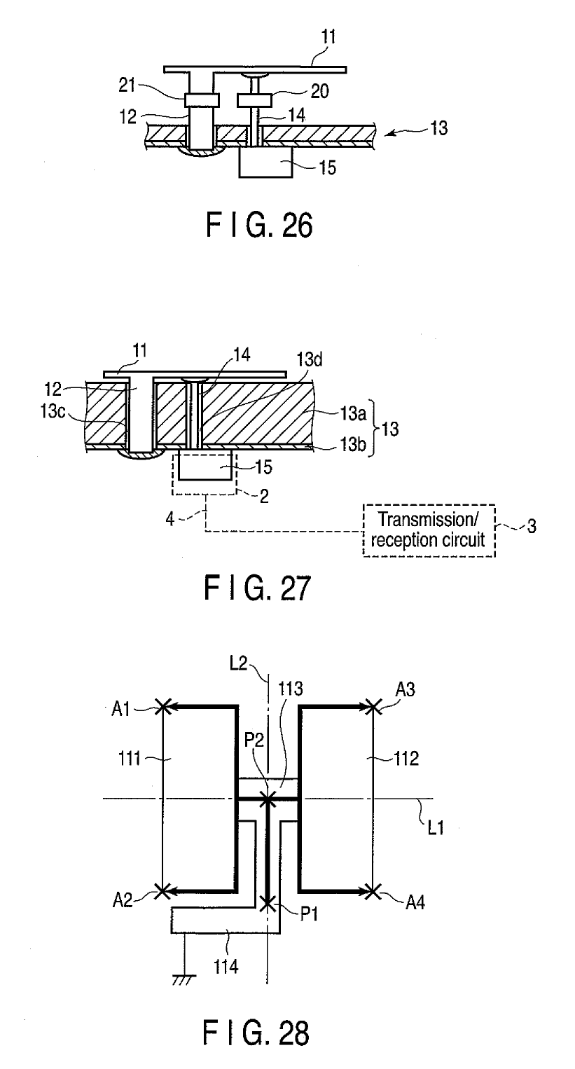

A passive element may be provided to a halfway point of at least one of an electrical path that connects a feed element 11 to a transmission/reception circuit 3 and an electrical path that grounds the feed element 11. In an example depicted in FIG. 26, passive elements 20 and 21 are provided to a halfway point of a feeder line 14 and a halfway point of a short-circuit element 12, respectively. It is to be noted that the passive element is a circuit formed of a coil, a capacitor, or both a coil and a capacitor.

### Seventh Modification

As shown in FIG. 27, a thickness of a flat plate 13a may be increased so that the flat plate 13a can present in substantially all of a space between a coupling element 11 and an electrode 13b. It is to be noted that such a modification is also effective in the configurations shown in FIG. 24 to FIG. 26. Furthermore, such a configuration can be also realized by filling a space between the coupling element 11 and the flat plate 13a with a dielectric material in the configuration shown in each of FIG. 2 and FIG. 24 to FIG. 26.

### Eighth Modification

In a coupling element, each of rectangular portions 111 and 112 in the coupling element 11 may have a size that allows a high-frequency signal to be supplied to a substantially entire region like a coupling portion 113. For example, as shown in FIG. 28, a width of each of the rectangular portions 111 and 112 in the Y direction is increased. It is to be noted that, in this case, a current is produced in an edge portion in the rectangular portion 111. Therefore, a current path branches into two at a boundary between the rectangular portion 111 and the coupling portion 113 so that branched paths can reach corner portions A1 and A2 along upper and lower edge portions in FIG. 28. In the rectangular portion 112, likewise, a current path branches into two at a boundary between the rectangular portion 112 and the coupling portion 113 so that branched paths can reach corner portions A3 and A4 along the upper and lower edge portions in FIG. 28.

Therefore, four current paths that reach the corner portions A1, A2, A3, and A4 from a feeding point P1 are formed. Thus, the corner portions A1, A2, A3, and A4 become open ends. It is to be noted that, since positions of the current paths in the rectangular portions 111 and 112 vary, at least either a length of each of the rectangular portions 111 and 112 in the X direction or a length of the coupling portion 113 in the Y direction is changed to adjust a length of each current path to a length substantially corresponding to ¼ of a wavelength λ of a central frequency of the signal. In the example depicted in FIG. 28, the length of each of the rectangular portions 111 and 112 in the X direction is not changed, but the length of the coupling portion 113 in the Y direction is reduced.

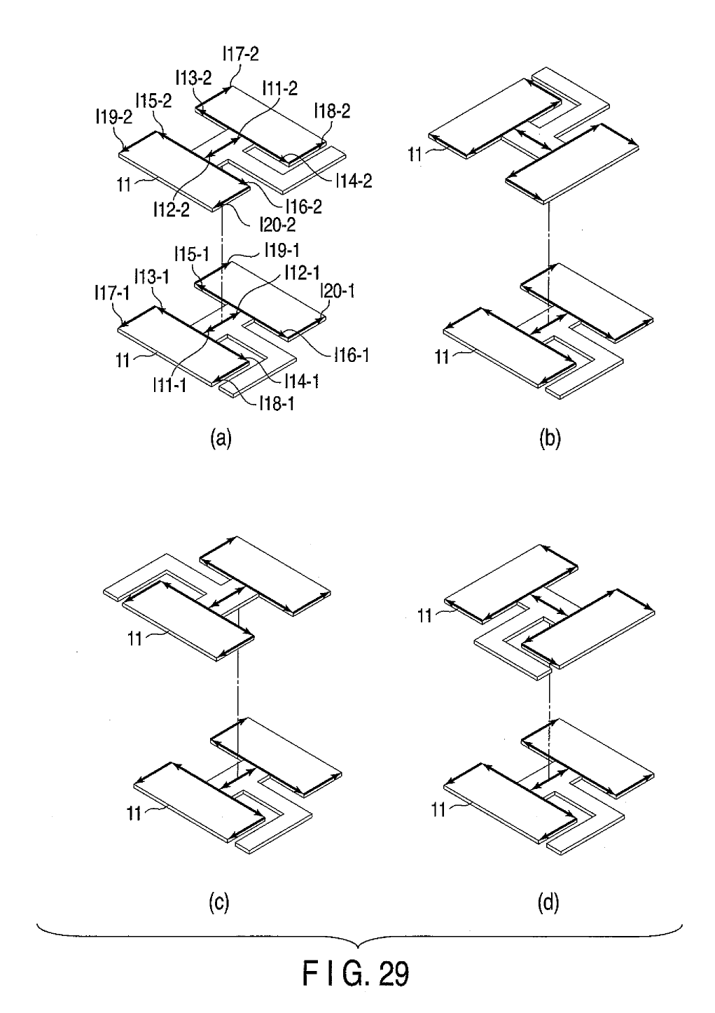

Even in a case where the coupling element 11 is modified in this manner, a current whose direction is opposite to that of a current produced in one coupling element 11 is produced in the other coupling element 11 in all of four states shown in FIG. 29. Incidentally, assuming that currents flowing from a branching point P2 toward the rectangular portions 111 and 112 are represented as I11 and I12, currents branched from the current I11 toward the corner portions A1 and A2 are represented as I13 and I14, currents branched from the current I12 toward the corner portions A3 and A4 are represented as I15 and I16, currents obtained by changing directions of the currents I13, I14, I15, and I16 to reach the corner portions A1, A2, A3, and A4 are represented as I17, I18, I19, and I20, “−1” is added to the above-described signs in regard to the currents concerning to one coupling element 11, and “−2” is added to the above-described signs in regard to the currents concerning the other coupling element 11, the following currents have directions opposite to each other in each of the four states shown in FIG. 29.

FIG. 29(a): I11-1, I17-1, I18-1, I11-2, I17-2, and I18-2; I12-1, I19-1, I20-1, I12-2, I19-2, and I20-2; I13-1, I15-1, I14-2, and I16-2; and I14-1, I16-1, I13-2, and I15-2.

FIG. 29(b): I11-1, I17-1, I18-1, I14-2, and I16-2; I12-1, I19-1, I20-1, I13-2, and I15-2; I13-1, I15-1, I12-2, I19-2, and I20-2; and I14-1, I16-1, I11-2, I17-2, and I18-2.

FIG. 29(c): I11-1, I17-1, I18-1, I12-2, I19-2, and I20-2; I12-1, I19-1, I20-1, I11-2, I17-2, and I18-2; I13-1, I15-1, I13-2, I15-2; and I14-1, I16-1, I14-2, and I16-2.

FIG. 29(d): I11-1, I17-1, I18-1, I13-2, and I15-2; I12-1, I19-1, I20-1, I14-2, and I16-2; I13-1, I15-1, I11-2, I17-2, and I18-2; I14-1, I16-1, I12-2, I19-2, and I20-2.

Thus, the same effect as that of the foregoing embodiment can be obtained even if the coupling element is modified as described above.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coupling element configured to transmit or receive an electromagnetic wave to or from another coupling element by electromagnetic coupling with the another coupling element, satisfying conditions comprising:
the coupling element which is a conductive material formed in a tabular shape having a first rectangular portion whose size enables a high-frequency signal to be supplied in a substantially entire region thereof, a second portion connected to a first end of the first portion, the second portion having first and second open ends, and a third portion connected to a second end opposite to the first end of the first portion, the third portion having third and fourth open ends;
first, second, third and fourth current paths extending from a central point of the first portion through the first portion to the first, second, third and fourth open ends, respectively, each of lengths of the current paths having a length substantially corresponding to an integral multiple of ¼ of a wavelength of a central frequency of an electromagnetic wave;
the first and second current paths extending to the second portion in the same direction on the first portion and branching out oppositely to each other to extend to the first and second open ends, respectively;
the third and fourth current paths extending to the third portion in the same direction on the first portion and branching out oppositely to each other to extend to the third and fourth open ends, respectively;
a first straight line running through the central point of the first portion, where the first straight line is determined as a symmetric axis, the first and second open ends are provided at substantially symmetrical positions, and the third and fourth open ends are provided at substantially symmetrical positions; and
a second straight line that runs through the central point of the first portion and is orthogonal to the first straight line, where the second line is determined as a symmetric axis, the first and third open ends are provided at substantially symmetrical positions, and the second and fourth open ends are provided at substantially symmetrical positions.

2. The coupling element of claim 1, wherein a reference point as a feeding point is different from the central point of the first portion.

3. The coupling element of claim 1, wherein a reference point as a feeding point is the same as the central point of the first portion.

4. The coupling element of claim 1, wherein lengths of the first, second, third and fourth current paths correspond to substantially ¼ of a wavelength of a central frequency of the electromagnetic wave.

5. A coupler apparatus which transmits or receives electromagnetic waves to or from another coupler apparatus arranged to be apart from each other, the coupler apparatus comprising:
a coupling element;
a substrate which is arranged to be apart from the coupling element and comprises a ground electrode that is grounded; and
a conductive member which achieves electrical conduction between the coupling element and the ground electrode,
the coupling element being configured to satisfy conditions comprising:
the coupling element which is a conductive material formed in a tabular shape having a first rectangular portion whose size enables a high-frequency signal to be supplied in a substantially entire region thereof, a second portion connected to a first end of the first portion, the second portion having first and second open ends, and a third portion connected to a second end opposite to the first end of the first portion, the third portion having third and fourth open ends;
first, second, third and fourth current paths extending from a central point of the first portion through the first portion to the first, second, third and fourth open ends, respectively, each of lengths of the current paths having a length substantially corresponding to an integral multiple of ¼ of a wavelength of a central frequency of an electromagnetic wave;
the first and second current paths extending to the second portion in the same direction on the first portion and branching out oppositely to each other to extend to the first and second open ends, respectively;
the third and fourth current paths extending to the third portion in the same direction on the first portion and branching out oppositely to each other to extend to the third and fourth open ends, respectively;
a first straight line running through the central point of the first portion, where the first straight line is determined as a symmetric axis, the first and second open ends are provided at substantially symmetrical positions, and the third and fourth open ends are provided at substantially symmetrical positions; and
a second straight line that runs through the central point of the first portion and is orthogonal to the first straight line, where the second line is determined as a symmetric axis, the first and third open ends are provided at substantially symmetrical positions, and the second and fourth open ends are provided at substantially symmetrical positions.

6. The apparatus of claim 5, wherein the coupling element and the substrate are arranged in a positional relationship that the central point of the first portion and a central point of the ground electrode are aligned in a separating direction of the coupling element and the substrate.

7. The apparatus of claim 5, wherein the coupling element and the substrate are arranged in a positional relationship that a point to which the conductive member is connected in the coupling element and a central point of the ground electrode are aligned in a separating direction of the coupling element and the substrate.

8. The apparatus of claim 5, further comprising a parasitic element which is arranged in proximity to the coupling element, formed of a conductive material, and electrically connected to the ground electrode.
